(19) United States
(12) Patent Application Publication
(10) Pub. No.: US 2013/0208212 A1
(43) Pub. Date: Aug. 15, 2013

(54) BACKLIGHT MODULE AND LIQUID CRYSTAL DISPLAY

(71) Applicants: Chengwen Que, Shenzhen (CN); Shih-hsiang Chen, Shenzhen (CN)

(72) Inventors: Chengwen Que, Shenzhen (CN); Shih-hsiang Chen, Shenzhen (CN)

(73) Assignee: SHENZHEN CHINA STAR OPTOELECTRONICS TECHNOLOGY CO. LTD., Shenzhen (CN)

(21) Appl. No.: 13/498,961

(22) PCT Filed: Feb. 10, 2012
(86) PCT No.: PCT/CN12/71030

§ 371 Date: Mar. 29, 2012

(30) Foreign Application Priority Data
Feb. 9, 2012 (CN) 201210028897.X

(51) Int. Cl. G09F 13/04; G02F 1/13357

(52) U.S. Cl. 349/61; 362/97.1

(57) ABSTRACT

A backlight module and a liquid crystal display are provided. The backlight module includes a light source, a heat dissipating bracket and a back plate. There disposes a heat conduction filling layer between the heat dissipating bracket and the back plate. After compressing the heat dissipating bracket and the back plate, the heat conduction filling layer is filled into the gap between the heat dissipating bracket and the back plate for further transferring the heat conducted by the heat dissipating bracket to the back plate. The present invention increases the efficiency of heat conduction and dissipation.

### BACKGROUND OF THE INVENTION

1. Field of the Invention

The present invention relates to a liquid crystal displaying technology field, and more particularly to a backlight module and a liquid crystal display.

2. Description of the Prior Art

With the continuous development and the popularity of a liquid crystal display, the demand for the function of every component of the liquid crystal display becomes more and more high.

In the prior art, a light source of the liquid crystal display generally adopts an LED (Light Emitting Diode), but the luminous efficiency of the LED and the life thereof may be decreased with the increase of the heat quantity. Hence, it is a research direction of the liquid crystal displaying technology field that how to solve the heat dissipating problem of the LED.

Please refer to FIG. 1, FIG. 1 is a structure schematic view of a side-light type LED backlight module, the side-light type LED backlight module includes a front frame 11, a middle frame 12, an LED 13, a heat dissipating bracket 14, a back plate 15, a light guide plate 16 and so on.

Wherein, the LED 13 is fixed on the heat dissipating bracket 14, and the heat dissipating bracket 14 is located on the back plate 15. The heat produced during the working process of the LED 13 is transferred to the back plate 15 through the heat dissipating bracket 14, and the back plate 15 can realize the heat dissipation by the heat exchange with the environmental air.

However, because the heat dissipating bracket 14 and the back plate 15 are rigid structure bodies, the surface rigidity thereof is high. In the manufacturing process of the heat dissipating bracket 14 and the back plate 15, each surface thereof has a certain roughness. Generally, the manufacturing precision is lower, the surface roughness is higher. As shown in FIG. 2, after the surfaces of the heat dissipating bracket 14 and the back plate 15 are enlarged, the uneven shape will appear on these surfaces, so that when the heat dissipating bracket 14 and the back plate 15 are in contact with each other, more gaps 17 will be generated therebetween (please refer to FIG. 2). Due to the existence of the gaps 17, the heat dissipating bracket 14 can not tightly attached to the back plate 15, such that the heat dissipating bracket 14 can not efficiently transfer the heat produced by the LED 13 to the back plate 15, and it will greatly reduce the heat dissipation efficiency of the LED 13.

As described above, because of the surface roughness of the heat dissipating bracket 14 and the back plate 15, more gaps will exist between them when they are attached together, to affect the heat conduction and reduce the heat dissipation efficiency. Hence, it is one of the technology problems needed to be solved in the liquid crystal displaying technology field that how to efficiently eliminate the above problem.

### BRIEF SUMMARY OF THE INVENTION

One object of the present invention is to provide a backlight module to solve the technical problems that because of the surface roughness of the heat dissipating bracket and the back plate, more gaps will exist between them when they are attached together, to affect the heat conduction and reduce the heat dissipation efficiency in the prior art.

For solving above problems, the present invention provides a backlight module, comprising a light source, a heat dissipating bracket connected to the light source and used to conduct the heat produced by the light source, and a back plate connected to the heat dissipating bracket and for dissipating the heat conducted by the heat dissipating bracket.

There disposes a heat conduction filling layer between the heat dissipating bracket and the back plate. The heat conduction filling layer is made of a soft metal material. The heat conduction filling layer is fixed on a bottom surface, which is connected to the back plate, of the heat dissipating bracket by coating or attaching way. The heat conduction filling layer is a solder paste layer or a soft metal foil.

After compressing the heat dissipating bracket and the back plate, the heat conduction filling layer is filled into the gap between the heat dissipating bracket and the back plate. The heat conduction filling layer is used to further transfer the heat produced by the light source and conducted by the heat dissipating bracket to the back plate.

In the backlight module of the present invention, the heat dissipating bracket disposes a first screw hole, the heat conduction filling layer disposes a second screw hole, and the back plate disposes a third screw hole, and the backlight module also comprises a nut, which passes through and screwedly connects the first screw hole, the second screw hole and the third screw hole to compress the heat dissipating bracket and the back plate for squeezing the heat conduction filling layer.

Another object of the present invention is to provide a backlight module to solve the technical problems that because of the surface roughness of the heat dissipating bracket and the back plate, more gaps will exist between them when they are attached together, to affect the heat conduction and reduce the heat dissipation efficiency in the prior art.

For solving above problems, the present invention provides a backlight module, comprising a light source, a heat dissipating bracket connected to the light source and used to conduct the heat produced by the light source, and a back plate connected to the heat dissipating bracket and for dissipating the heat conducted by the heat dissipating bracket.

There disposes a heat conduction filling layer between the heat dissipating bracket and the back plate. After compressing the heat dissipating bracket and the back plate, the heat conduction filling layer is filled into the gap between the heat dissipating bracket and the back plate. The heat conduction filling layer is used to further transfer the heat produced by the light source and conducted by the heat dissipating bracket to the back plate.

In the backlight module of the present invention, the heat conduction filling layer is made of a soft metal material.

In the backlight module of the present invention, the heat conduction filling layer is fixed on a bottom surface, which is connected to the back plate, of the heat dissipating bracket by coating or attaching way.

In the backlight module of the present invention, the heat dissipating bracket disposes a first screw hole, the heat conduction filling layer disposes a second screw hole, and the back plate disposes a third screw hole, and the backlight module also comprises a nut, which passes through and screwedly connects the first screw hole, the second screw hole and the third screw hole to compress the heat dissipating bracket and the back plate for squeezing the heat conduction filling layer.

In the backlight module of the present invention, the heat conduction filling layer is a solder paste layer or a soft metal foil.

Another object of the present invention is to provide a liquid crystal display to solve the technical problems that because of the surface roughness of the heat dissipating bracket and the back plate, more gaps will exist between them when they are attached together, to affect the heat conduction and reduce the heat dissipation efficiency in the prior art.

For solving above problems, the present invention provides a liquid crystal display. The liquid crystal display comprises a backlight module. The backlight module comprises a light source, a heat dissipating bracket connected to the light source and used to conduct the heat produced by the light source, and a back plate connected to the heat dissipating bracket and for dissipating the heat conducted by the heat dissipating bracket. There disposes a heat conduction filling layer between the heat dissipating bracket and the back plate. After compressing the heat dissipating bracket and the back plate, the heat conduction filling layer is filled into the gap between the heat dissipating bracket and the back plate.

When the light source works, the heat conduction filling layer is used to further transfer the heat produced by the light source and conducted by the heat dissipating bracket to the back plate.

In the liquid crystal display of the present invention, the heat conduction filling layer is made of a soft metal material.

In the liquid crystal display of the present invention, the heat conduction filling layer is fixed on a bottom surface, which is connected to the back plate, of the heat dissipating bracket by coating or attaching way.

In the liquid crystal display of the present invention, the heat dissipating bracket disposes a first screw hole, the heat conduction filling layer disposes a second screw hole, and the back plate disposes a third screw hole, and the backlight module also comprises a nut, which passes through and screwedly connects the first screw hole, the second screw hole and the third screw hole to compress the heat dissipating bracket and the back plate for squeezing the heat conduction filling layer.

In the liquid crystal display of the present invention, the heat conduction filling layer is a solder paste layer or a soft metal foil.

Comparing with the prior art, the present invention disposes the heat conduction filling layer between the heat dissipating bracket and the back plate. After compressing the heat dissipating bracket and the back plate, the heat conduction filling layer can be filled into the gap between the heat dissipating bracket and the back plate, to make the heat conducted by the heat dissipating bracket be efficiently transferred to the back plate, and then be dissipated by the back plate, thereby largely increasing the efficiency of heat conduction and dissipation.

For more clearly and easily understanding above content of the present invention, the following text will take a preferred embodiment of the present invention with reference to the accompanying drawings for detail description as follows.

### BRIEF DESCRIPTION OF THE DRAWINGS

FIG. 1 is a structure schematic view of a backlight module in the prior art;

FIG. 2 is an enlarged effect schematic view after surfaces of a heat dissipating bracket and a back plate shown in FIG. 1 being attached together;

FIG. 3 is a structure schematic view of a preferred embodiment of a backlight module of the present invention;

FIG. 4 is an assembly schematic view of a first preferred embodiment of a heat dissipating bracket, a heat conduction filling layer and a back plate of the backlight module of the present invention, to enlargedly show the fitting effect of the surfaces of the heat dissipating bracket and the back plate; and

FIG. 5 is an assembly schematic view of a second preferred embodiment of a heat dissipating bracket, a heat conduction filling layer and a back plate of the backlight module of the present invention.

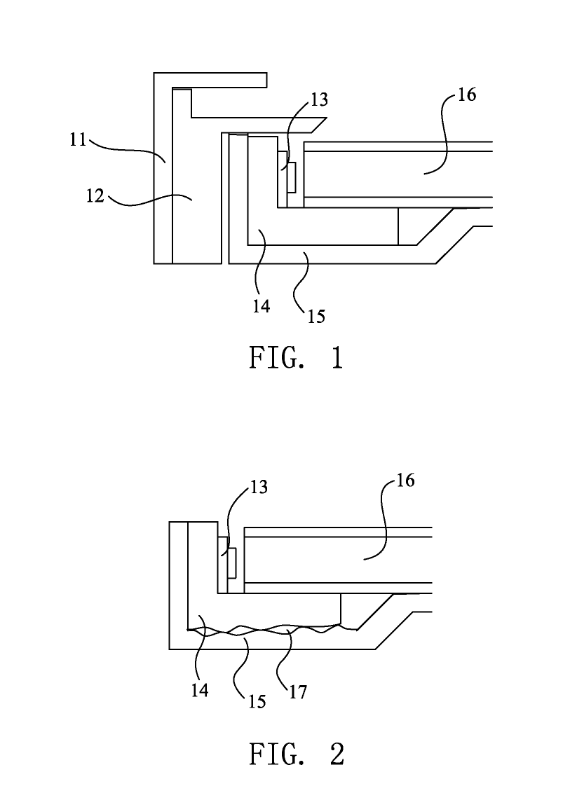

### DETAILED DESCRIPTION OF THE PREFERRED EMBODIMENTS

The following description of every embodiment with reference to the accompanying drawings is used to exemplify a specific embodiment, which may be carried out in the present invention.

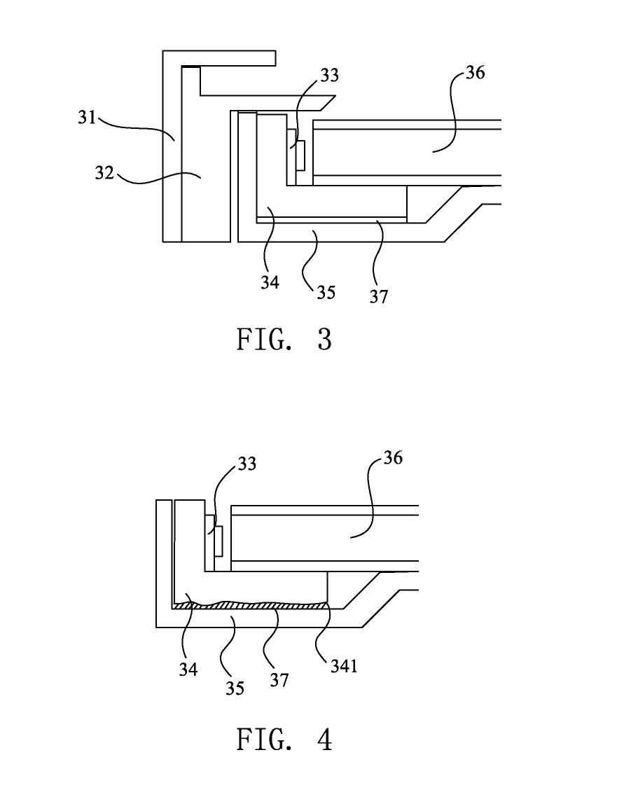

FIG. 3 is a structure schematic view of a preferred embodiment of a backlight module of the present invention.

The backlight module comprises a front frame 31, a middle frame 32, a light source 33, a heat dissipating bracket 34, a back plate 35, a light guide plate 36 and a heat conduction filling layer 37.

Wherein, the front frame 31 is mounted on the external of the middle frame 32, the middle frame 32 is used to load a display screen (not shown in drawings). The back plate 35 is mounted in the internal of the middle frame 32. The light source 33 is disposed on the heat dissipating bracket 34, and the heat dissipating bracket 34 is attached to the back plate 35. The heat conduction filling layer 37 is located between the heat dissipating bracket 34 and the back plate 35. Preferably, the heat conduction filling layer 37 is made of a soft metal material.

When the light source 33 is working, the heat dissipating bracket 34 is used to transfer the heat produced by the light source 33 to the heat conduction filling layer 37, the heat conduction filling layer 37 is used to further transfer the heat coming from the heat dissipating bracket 34 to the back plate 35, and the back plate 35 is used to dissipate the heat coming from the heat conduction filling layer 37.

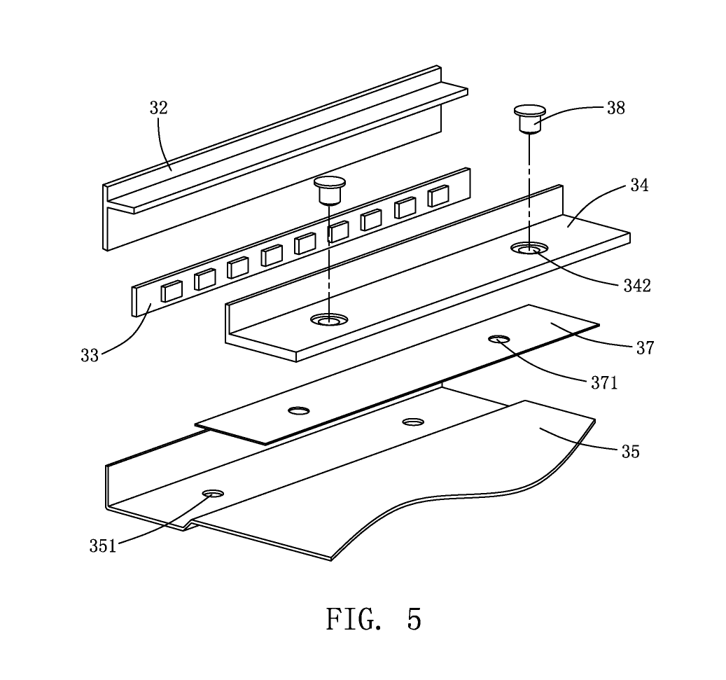

Please refer to FIG. 4, FIG. 4 is an assembly schematic view of a first preferred embodiment of the heat dissipating bracket 34, the heat conduction filling layer 37 and the back plate 35 of the backlight module of the present invention, to enlargedly show the fitting effect of the surfaces of the heat dissipating bracket 34 and the back plate 35.

In the embodiment shown by FIG. 4, the heat conduction filling layer 37 is preferably a solder paste layer. The solder paste layer is coated on a bottom surface 341 of the heat dissipating bracket 34, which is used to be connected to the back plate 35.

After the heat dissipating bracket 34 is attached to the back plate 35, the heat conduction filling layer 37 (the solder paste layer) may be directly filled into the gap between the heat dissipating bracket 34 and the back plate 35.

Please refer to FIG. 5, FIG. 5 is an assembly schematic view of a second preferred embodiment of the heat dissipating bracket 34, the heat conduction filling layer 37 and the back plate 35 of the backlight module of the present invention.

In the embodiment shown by FIG. 5, the heat conduction filling layer 37 is preferably a soft metal foil, the soft metal foil is attached to the bottom surface (not labeled in FIG. 5) of the heat dissipating bracket 34, which is used to be connected to the back plate 35.

Please continue referring to FIG. 5, the heat dissipating bracket 34 disposes a first screw hole 342, the heat conduction filling layer 37 disposes a second screw hole 371, and the back plate 35 disposes a third screw hole 351. A nut 38, which passes through and screwedly connects the first screw hole 342, the second screw hole 371 and the third screw hole 351, is used to compress the heat dissipating bracket 34 and the back plate 35 and squeeze the heat conduction filling layer 37 to make the heat conduction filling layer 37 (the soft metal foil) be filled into the gap between the heat dissipating bracket 34 and the back plate 35.

Certainly, in the specific implementation process, in addition to the solder paste layer and the soft metal foil, the heat conduction filling layer 37 may be other soft metal materials, which can be filled into the gap between the heat dissipating bracket 34 and the back plate 35 and can transfer the heat coming from the heat dissipating bracket 34 to the back plate 35. They are not listed one by one here.

The working principle of the preferred embodiment of the backlight module provided by the present invention is as follows:

when the light source 33 emits light, the heat produced by the light source 33 is conducted by the heat dissipating bracket 34, and the heat conducted by the heat dissipating bracket 34 passes through the heat conduction filling layer 37 and is transferred to the back plate 35.

Because the gap between the heat dissipating bracket 34 and the back plate 35 is fully filled with the heat conduction filling layer 37, the heat conducted by the heat dissipating bracket 34 may be efficiently transferred to the back plate 35 by the heat conduction filling layer 37.

The back plate 35 can exchange the heat conducted by the heat conduction filling layer 37 with the environmental air, thereby dissipating heat.

The present invention also provides a liquid crystal display. The liquid crystal display comprises the backlight module provided by the present invention. The backlight module comprises the light source 33, the heat dissipating bracket 34 connected to the light source 33 and used to conduct the heat produced by the light source, and the back plate 35 for dissipating the heat conducted by the heat dissipating bracket 34. There disposes the heat conduction filling layer 37 between the heat dissipating bracket 34 and the back plate 35. After compressing the heat dissipating bracket 34 and the back plate 35, the heat conduction filling layer 37 is filled into the gap between the heat dissipating bracket 34 and the back plate 35. The heat conduction filling layer 37 can further transfer the heat produced by the light source 33 and conducted by the heat dissipating bracket 34 to the back plate 35. In view of the structure of the backlight module and the working principle thereof having been described in detail, there is no repeated here.

The present invention employs the heat conduction filling layer 37 disposed between the heat dissipating bracket 34 and the back plate 35. After compressing the heat dissipating bracket 34 and the back plate 35, the heat conduction filling layer 37 can be filled into the gap between the heat dissipating bracket 34 and the back plate 35, to make the heat conducted by the heat dissipating bracket 34 be efficiently transferred to the back plate 35, and be dissipated by the back plate 35, thereby largely increasing the efficiency of heat conduction and dissipation.

In conclusion, although the present invention has been disclosed by above preferred embodiments, above preferred embodiments are not used to limit the present invention. One of ordinary skills in the art also can make all sorts of improvements and amendments within the principles of the present invention. Therefore, the protection scope of the present invention should be based on the scope defined by the appended claims.

What is claimed is:

1. A backlight module, comprising a light source, a heat dissipating bracket connected to the light source and used to conduct the heat produced by the light source, and a back plate connected to the heat dissipating bracket and for dissipating the heat conducted by the heat dissipating bracket, wherein:
there disposes a heat conduction filling layer between the heat dissipating bracket and the back plate, the heat conduction filling layer being made of a soft metal material, the heat conduction filling layer being fixed on a bottom surface, which is connected to the back plate, of the heat dissipating bracket by coating or attaching way, the heat conduction filling layer being a solder paste layer or a soft metal foil;
after compressing the heat dissipating bracket and the back plate, the heat conduction filling layer being filled into the gap between the heat dissipating bracket and the back plate, the heat conduction filling layer being used to further transfer the heat produced by the light source and conducted by the heat dissipating bracket to the back plate.

2. The backlight module as claimed in claim 1, wherein the heat dissipating bracket disposes a first screw hole, the heat conduction filling layer disposes a second screw hole, and the back plate disposes a third screw hole, and the backlight module also comprises a nut, which passes through and screwedly connects the first screw hole, the second screw hole and the third screw hole to compress the heat dissipating bracket and the back plate for squeezing the heat conduction filling layer.

3. A backlight module, comprising a light source, a heat dissipating bracket connected to the light source and used to conduct the heat produced by the light source, and a back plate connected to the heat dissipating bracket and for dissipating the heat conducted by the heat dissipating bracket, wherein:
there disposes a heat conduction filling layer between the heat dissipating bracket and the back plate, after compressing the heat dissipating bracket and the back plate, the heat conduction filling layer being filled into the gap between the heat dissipating bracket and the back plate, the heat conduction filling layer being used to further transfer the heat produced by the light source and conducted by the heat dissipating bracket to the back plate.

4. The backlight module as claimed in claim 3, wherein the heat conduction filling layer is made of a soft metal material.

5. The backlight module as claimed in claim 4, wherein the heat conduction filling layer is fixed on a bottom surface, which is connected to the back plate, of the heat dissipating bracket by coating or attaching way.

6. The backlight module as claimed in claim 3, wherein the heat dissipating bracket disposes a first screw hole, the heat conduction filling layer disposes a second screw hole, and the back plate disposes a third screw hole, and the backlight module also comprises a nut, which passes through and screwedly connects the first screw hole, the second screw hole and the third screw hole to compress the heat dissipating bracket and the back plate for squeezing the heat conduction filling layer.

7. The backlight module as claimed in claim 4, wherein the heat conduction filling layer is a solder paste layer or a soft metal foil.

8. A liquid crystal display, comprising a backlight module, wherein the backlight module comprises a light source, a heat dissipating bracket connected to the light source and used to conduct the heat produced by the light source, and a back plate connected to the heat dissipating bracket and for dissipating the heat conducted by the heat dissipating bracket;
there disposing a heat conduction filling layer between the heat dissipating bracket and the back plate, after compressing the heat dissipating bracket and the back plate, the heat conduction filling layer being filled into the gap between the heat dissipating bracket and the back plate, the heat conduction filling layer being used to further transfer the heat produced by the light source and conducted by the heat dissipating bracket to the back plate.

9. The liquid crystal display as claimed in claim 8, wherein the heat conduction filling layer is made of a soft metal material.

10. The liquid crystal display as claimed in claim 9, wherein the heat conduction filling layer is fixed on a bottom surface, which is connected to the back plate, of the heat dissipating bracket by coating or attaching way.

11. The liquid crystal display as claimed in claim 8, wherein the heat dissipating bracket disposes a first screw hole, the heat conduction filling layer disposes a second screw hole, and the back plate disposes a third screw hole, and the backlight module also comprises a nut, which passes through and screwedly connects the first screw hole, the second screw hole and the third screw hole to compress the heat dissipating bracket and the back plate for squeezing the heat conduction filling layer.

12. The liquid crystal display as claimed in claim 9, wherein the heat conduction filling layer is a solder paste layer or a soft metal foil.
